(19) United States
(12) Patent Application Publication
(10) Pub. No.: US 2026/0313374 A1
(43) Pub. Date: Oct. 8, 2026

(54) PROXIMITY SERVICES SECONDARY AUTHENTICATION USING LOCALLY CONFIGURED DNN INFORMATION

(71) Applicant: InterDigital Patent Holdings, Inc., Wilmington, DE (US)

(72) Inventors: Samir FERDI, Kirkland (CA); Michelle PERRAS, Montréal (CA); Jung Je SON, Warrington, PA (US)

(73) Assignee: InterDigital Patent Holdings, Inc., Wilmington, DE (US)

(21) Appl. No.: 19/483,498

(22) PCT Filed: May 10, 2024
(86) PCT No.: PCT/US2024/028813

§ 371 Date: Nov. 11, 2025

Related U.S. Application Data
(60) Provisional application No. 63/465,771, filed on May 11, 2023.

(51) Int. Cl. H04W 12/06; H04W 76/14

(52) U.S. Cl. CPC H04W 12/06; H04W 76/14

(57) ABSTRACT

In one method, a relay WTRU receives during a relay service provisioning procedure, a data network (DN) authentication and authorization (A&A) required indication associated with a relay service code (RSC). The relay WTRU receives a connection request including a RSC and a remote user identity, and sends, to a session management function (SMF), a PDU session establishment/modification request message with the remote user identity and DNN associated with the RSC. The relay WTRU receives a PDU session accept message including a related DN A&A required indication associated with the DNN. The relay WTRU determines, based on the related DN A&A required indication from the SMF, a proximity services secondary authentication (ProSe SA) is required for the remote WTRU and sends, to the remote WTRU, a connection accept response indicating the ProSe SA associated with the RSC or DNN is required.

### CROSS-REFERENCE TO RELATED APPLICATIONS

This application claims the benefit of U.S. Provisional Application No. 63/465,771, filed May 11, 2023, the contents of which are incorporated herein by reference.

### BACKGROUND

Recent efforts in wireless communications have been directed to proximity services (ProSe) secondary authentication (SA) procedures and their potential implications to the fifth generation service (5GS) architecture. In existing 5G packet data unit (PDU) Session ProSe SA procedures, a session management function (SMF) checks mobile device subscription data retrieved from unified data management (UDM) to determine whether the data network (DN) a Remote user equipment (UE), connected to the 5G network through a Relay UE, is trying to access is subject to ProSe SA. However, DNs used in Relaying may not always be subject to ProSe SA, and in some scenarios, the procedure may need to support the case where the UDM of the Remote UE does not hold DNN information in the subscription data (e.g., depending on roaming agreements).

In these efforts, there remain issues to be solved relating to relaying data network name (DNN) configurations and ProSe SA configurations, determination that ProSe SA is required by the Relay device, handling multiple remote user IDs by a UE, also referred to herein as a wireless transmit and receive unit (WTRU), serving as a Relay, and/or reports to trigger ProSe SA of a Remote WTRU. Additional solutions that support dynamic policy and charging control (PCC) for remote WTRUs with ProSe SA/DN-AAA, among others, are also needed.

### SUMMARY

Aspects of embodiments described herein may utilize locally configured relay data network name (DNN) information to convey local information to the 5G core network (5GC) and Relay WTRU to determine locally that a data network (DN) is subject to proximity services secondary authentication (ProSe SA). Aspects allow support of deployments where the serving public land mobile network (PLMN) may provide access to a data network (DN) locally (e.g., with a local break out (LBO) scenario) that requires DN-level authentication/authorization (e.g., enterprise network, public network integrated non-public network (PNI-NPN). Aspects of embodiments allow foregoing the need for a pre-established roaming agreement with the HPLMN regarding the DNN (i.e., the need for DNN being pre-configured in the home PLMN (HPLMN)) and need to check with UDM for Remote UE/WTRU DNN subscription data. In one example aspect, a session management function (SMF) uses an indication in the relaying DNN local configuration or from a policy control function (PCF) to determine whether to initiate a ProSe SA for a Remote WTRU and/or contact unified data management (UDM) of the Remote WTRU. The Relay WTRU uses an indication from the PCF or from the SMF to determine that a DN authentication and authorization (A&A) (i.e., ProSe SA) is required for the DNN associated with the Relay service.

Aspects are also described where the Relay WTRU and 5G core network (5GC) may perform multiple ProSe SA procedures in parallel, triggered by a single Remote UE Report procedure. As used herein, a Remote UE Report may also be referred to as a Remote WTRU Report. The disclosed embodiments allow continued support for the existing Remote WTRU Report procedures, which enable reporting multiple Remote WTRU connections at once (i.e., to reduce Relay-Network signaling overhead), while supporting ProSe SA procedures and avoiding operations of the Remote WTRUs negatively impacting or interfering with one another. In one example, the SMF provides the Relay WTRU with a specific status indication for each Remote User ID in the Remote WTRU Report ACK based on individual operations progress and provide the Relay with final status in a subsequent message. The Relay WTRU allows or denies access to a Remote WTRU based on specific status indication for the Remote WTRU received from the SMF in the Remote WTRU Report acknowledgement (ACK) or a subsequent non-access stratum (NAS) message.

Further aspects and features are disclosed for the 5GC to initiate ProSe SA procedures for a Remote WTRU during the PC5 link establishment with the Relay WTRU. The disclosed embodiments allow reconciling IP address allocation operations performed either by the 5GC or by the data network authentication, authorization and accounting (DN-AAA) server, if required during ProSe SA, while preserving and reusing the existing Remote WTRU reporting procedures. In one example, the SMF triggers the Remote WTRU ProSe SA procedure on reception of a PDU Session Establishment or Modification Request from the U2N Relay (i.e., the Relay WTRU), based on local information in session management context of the Relay WTRU or subscription data.

Additional aspects are disclosed for the 5G core (5GC) network (e.g., session management function (SMF) and policy control function (PCF) to support dynamic policy and charging control (PCC) when a ProSe SA procedure is required for a packet data unit (PDU) session. Certain embodiments allow for the DN-AAA server to control the authorization and policy on a per individual Remote WTRU basis, while sharing a PDU Session of the Relay WTRU. Aspects of the embodiments enable preserving and reusing the existing interface definition between the SMF and DN-AAA server. In one example, the SMF provides Remote WTRU's information using the PDU session of Relay WTRU and when there is any update on the Remote WTRU's information for accessing the PDU session of Relay WTRU, e.g., DN authorization info from the DN-AAA after successful authorization, the SMF informs the updated information to the PCF. Based on the received information from the SMF, the PCF manages PDU session context per Remote WTRU. The PCF may update the Remote WTRU's subscription data to indicate the PCF for the PDU session via the Relay WTRU or register the binding support function (BSF) with information relating to Remote WTRU.

In one aspect, a method for a Relay WTRU may include receiving, from a policy control function (PCF) during a relay service provisioning procedure, a data network (DN) authentication and authorization (A&A) required indication for the relay service, associated with at least one of a relay service code (RSC) or a data network name (DNN). The Relay WTRU receives, from a Remote WTRU, a connection request including the RSC and a remote user identity and sends, to a session management function (SMF), a packet data unit (PDU) session establishment or modification request message including the remote user identity and the DNN associated with the RSC received from the Remote WTRU. The Relay WTRU receives, from the SMF, a PDU session accept message including a related DN A&A required indication associated with the DNN and determines, based on the related DN A&A required indication from the SMF, a proximity services secondary authentication (ProSe SA) procedure is required for the Remote WTRU. The Relay WTRU sends, to the Remote WTRU, a connection accept response indicating the ProSe SA procedure associated with the RSC/DNN is required.

In a further aspect, the Relay WTRU sends, to the SMF, a remote WTRU report request message including the remote user identity and forwards ProSe SA messages between the SMF and the Remote WTRU. In one example, the Relay WTRU receives, from the SMF, a remote WTRU report response/ACK including a result of the ProSe SA procedure for the Remote WTRU and modifies the connection/link with the remote WTRU to enable/disable a PDU session with the DN, based on the result of the ProSe SA procedure received in the remote WTRU report response. For example, when the result of the ProSe SA procedure is successful and a link modification is performed to enable the remote WTRU to access the DN or when the result is unsuccessful, a PC5 connection with the remote WTRU is released.

In another aspect, a method for a SMF may include storing a local configuration of information for a data network (DN) used for relay service. The local configuration may include at least one DN name (DNN) and an associated DN authentication authorization (A&A) required indication. The SMF receives a packet data unit (PDU) session establishment or modification request from a Relay WTRU for DN access by a Remote WTRU, including a remote user identity and an indicated DNN. The SMF determines proximity service (ProSe) secondary authentication (SA) is required for the Remote WTRU based, at least in part, on the remote user identity, the indicated DNN and/or the local configuration information. The SMF sends a PDU session establishment or modification response to the Relay WTRU including an indication that DN A&A is required for the remote WTRU. Next, the SMF receives a remote WTRU report request message from the Relay WTRU including the remote user identity and initiates a ProSe SA procedure for the Remote WTRU based on the received remote WTRU report request. The SMF sends a remote WTRU report response message to the Relay WTRU including a result of the ProSe SA procedure.

In some aspects, the SMF determines ProSe SA is required based on one or more of information received from unified data management (UDM) subscription data for the Remote WTRU or information received from a policy control function (PCF). The SMF may store, in a session management (SM) context of the Relay WTRU, at least one of the indication that DN A&A is required and/or the result of the ProSe SA procedure. In one example, the remote WTRU report response message includes the remote user identity, an extensible authentication protocol (EAP) message and authorization information for connection of the Remote WTRU. Additional aspects, features and advantages are disclosed in the embodiments which follow.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a network diagram illustrating a proximity services secondary authentication (ProSe SA) procedure using locally configured data network name (DNN) information according to example embodiments;

FIG. 3 is a flow diagram illustrating a method for a session management function (SMF) performing a ProSe SA procedure using locally configured DNN information according to example embodiments;

FIG. 4 is a flow diagram illustrating a method for a Relay wireless transmit receive unit (WTRU) performing a ProSe SA procedure for a single Remote WTRU using locally configured DNN information according to example embodiments;

FIG. 5 is a network diagram illustrating a Remote WTRU Report procedure with Multiple Remote User IDs for ProSe SA in a Remote WTRU Report request according to example embodiments;

FIG. 6 is a flow diagram illustrating a method for an SMF performing a ProSe SA procedure with Multiple Remote User IDs for ProSe SA in the Remote WTRU Report according to example embodiments;

FIG. 7 is a flow diagram illustrating a method for a Relay WTRU performing a ProSe SA procedure for multiple Remote WTRUs using Multiple User IDs for ProSe SA in the Remote WTRU Report according to example embodiments;

FIG. 8 is a network diagram illustrating a ProSe SA procedure triggered by a packet data unit (PDU) Session establishment/modification request according to example embodiments;

FIG. 9 is a flow diagram illustrating a method for a SMF performing a ProSe SA procedure triggered by a PDU Session establishment/modification request according to example embodiments;

FIG. 10 is a network diagram illustrating an example procedure for ProSe SA with support for dynamic policy and charging control (PCC) according to example embodiments;

FIG. 11 is a flow diagram illustrating a method for a SMF in ProSe SA with support for dynamic policy and charging control (PCC) according to example embodiments; and

FIG. 12 is a flow diagram illustrating a method for a policy control function (PCF) in ProSe SA with support for dynamic policy and charging control (PCC) according to example embodiments.

### DETAILED DESCRIPTION

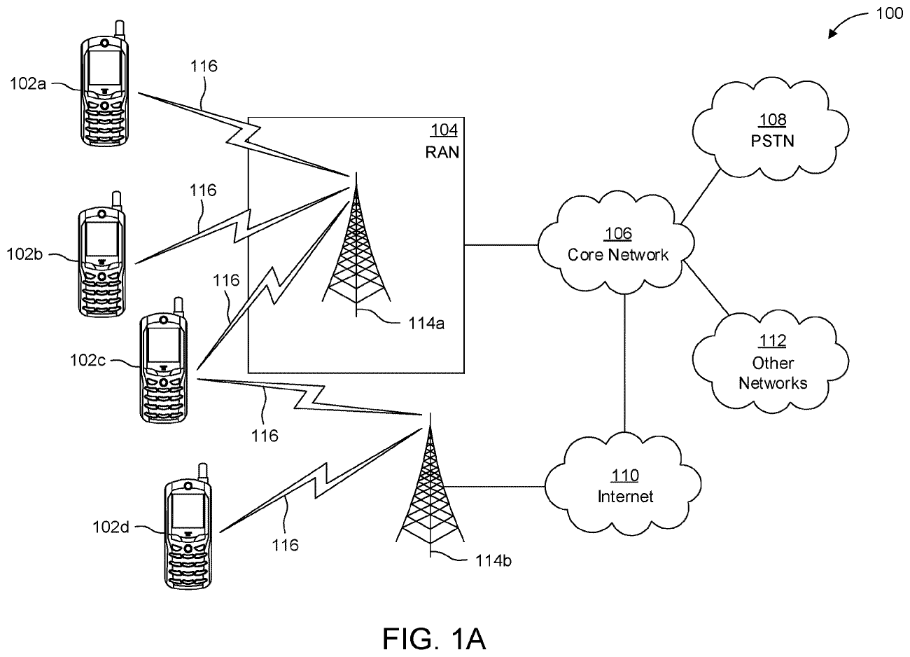

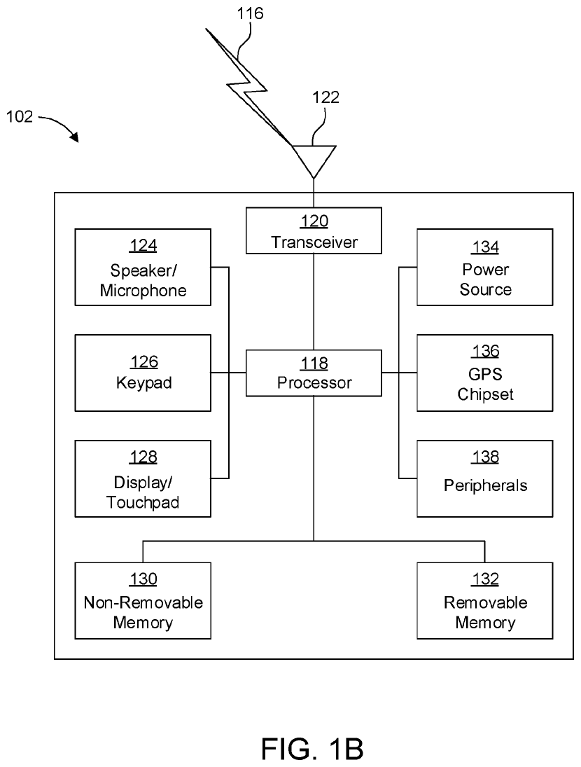

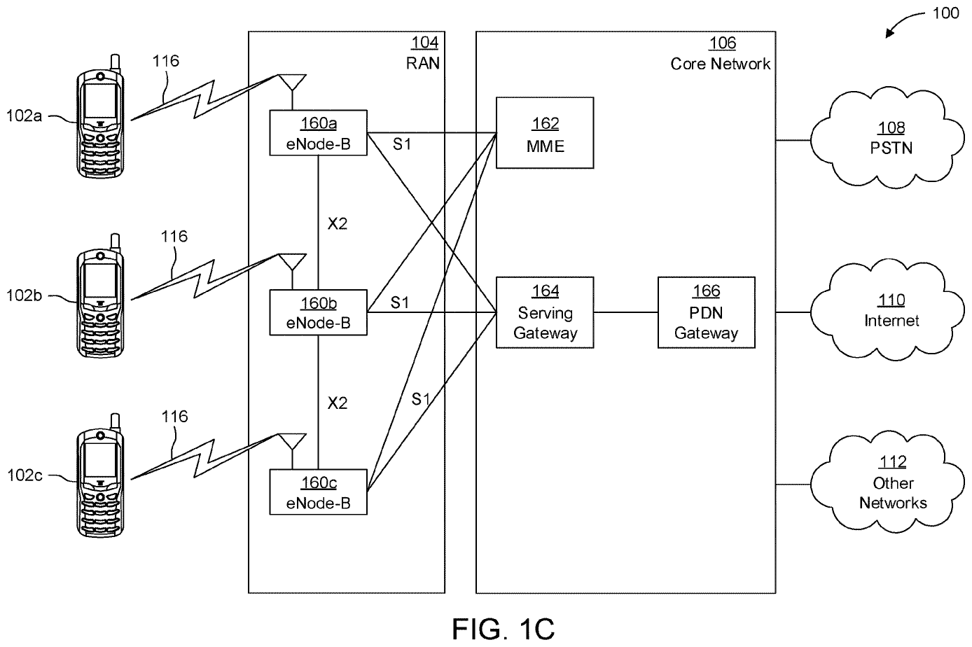

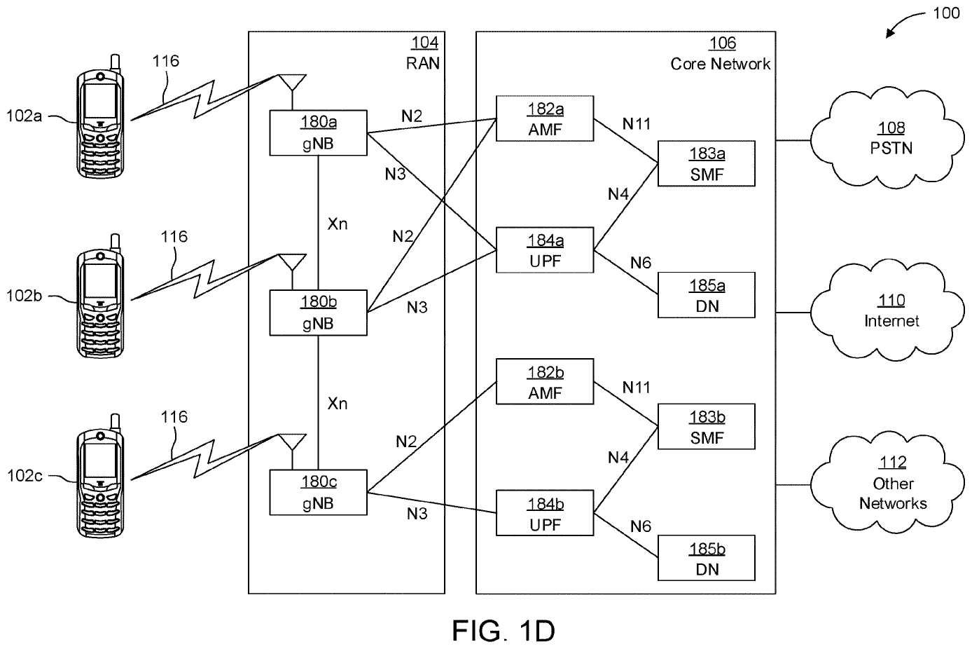

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications. one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In general context of performing a proximity services (ProSe) secondary authentication (SA) procedure, the Relay WTRU triggers the SMF to initiate a ProSe SA for a Remote WTRU as part of a Remote WTRU Report procedure. The Remote WTRU Report procedure follows a PC5 link establishment procedure between the Remote WTRU and the Relay WTRU. The PC5 link establishment security may be performed using a Control Plane (CP) or a User Plane (UP) approach. The Relay WTRU determines that a ProSe SA is required for the Remote WTRU during the PC5 link establishment, based on the fact that the Relay performed a PDU Session secondary authentication procedure itself, initiated by the SMF when establishing the PDU Session used for the relaying service.

In relaying a DNN local configuration, the DNN used for the Relay service is locally configured as a dedicated DNN in the SMF and PCF of the Relay WTRU. For the support of Local Breakout (LBO), the DNN used for relaying is a well-known DNN to allow seamless operations across various operators' networks.

Remote WTRU subscription permanent identifier (SUPI) resolution is performed by the SMF as part of the Remote WTRU Report procedure, using a ProSe remote user key (PRUK) ID of the Remote WTRU received from the Relay WTRU in a Remote WTRU Report message. The Remote WTRU SUPI resolution is required for regulatory services (e.g., Lawful Intercept, emergency services). The format of the Remote WTRU Report/Ack messages is previously defined.

For UE/WTRU-to-Network (U2N) Relay for emergency services, procedures have been defined for a U2N Relay to provide access to emergency services to Remote WTRUs. The Relay WTRU is configured with a relay service code (RSC) associated with a DNN dedicated for emergency services. The Relay WTRU provides a PDU Session to a Remote WTRU that requests to connect using the relay service code (RSC). The Relay WTRU may also use the PDU Session for its own emergency call needs.

As mentioned previously, there are open issues related to ProSe SA procedures and their potential implications to the 5GS architecture. One issue relates to relaying a data network name (DNN) configuration and ProSe SA configuration. The general issue here is how to reconcile usage of a local dedicated DNN configuration for relaying and network DN subscription data in unified data management (UDM) of the Remote WTRU. In existing PDU session secondary authentication or ProSe SA procedures, the SMF checks subscription data retrieved from the UDM to determine whether the DN the Remote WTRU is trying to access is subject to ProSe SA. However, DNs used in relaying may not be subject to ProSe SA and in some scenarios, the procedure may need to support the case where the UDM of the Remote WTRU does not hold DNN information in the subscription data (e.g., depending on roaming agreements). Hence, issues that may be addressed by the disclosed embodiments include: (i) how to determine that the DN is subject to ProSe SA in various deployment scenarios; and (ii) how to avoid the overhead of the SMF requesting DN subscription data from the UDM of the Remote WTRU for every DN used for relaying.

Another open issue the disclosed embodiments may address is deciding that ProSe SA is required by the Relay WTRU providing DN access to the Remote WTRU. The general issue is whether the Relay WTRU may determine to perform ProSe SA for the Remote WTRU based on prior PDU Session secondary authentication procedures run by the Relay WTRU, depending on whether the Relay WTRU can be authorized to use the relaying PDU session for its own traffic. There may be some restrictions put by the mobile network operator (MNO) and/or DN such that the Relay WTRU is not allowed to use the PDU Session to send its own traffic to the relaying DN. Hence, an issue that may be addressed by one or more of the disclosed embodiments is how to make the Relay WTRU be aware that ProSe SA is to be performed for a Remote WTRU, without the need for the Relay WTRU having to perform a prior ProSe SA.

In the case of multiple Remote User IDs with ProSe SA, one general issue addressed by the disclosed embodiments is how to support Multiple Remote User IDs in the Remote WTRU Report for ProSe SA, i.e., handling of multiple concurrent ProSe SAs by the SMF and the Relay WTRU. When the SMF receives a Remote WTRU Report including multiple Remote User IDs, the SMF needs to initiate and complete one or more operations for each Remote WTRU (e.g., Remote WTRU SUPI Resolution, ProSe SA) before the SMF can send a Remote WTRU Report Ack to the Relay WTRU.

Remote WTRUs for which the operations are successful are impacted (e.g., access delayed, blocked) if one or more of the operations for one or more of the Remote WTRUs fails (e.g., timeout). For example, if the Remote WTRU Report timer (T3586) expires, the Relay WTRU is not able to determine whether authentication/authorization operation(s) succeeded or failed for the Remote WTRUs, i.e., the Relay WTRU cannot decide to grant or deny access.

A mechanism to send an encrypted international mobile subscriber identity (IMSI) in a separate Remote WTRU Report to perform decryption of the IMSI by a ProSe Key Management Function (PKMF) was defined previously in LTE. However, using separate Remote WTRU Reports may incur significant signaling overhead with multiple Remote WTRUs performing ProSe SA. Hence, how to support multiple Remote User IDs in a Remote WTRU Report for the Relay to trigger the SMF to initiate one or more ProSe SAs (e.g., concurrently) may be addressed in the following embodiments. Embodiments presented herein may reducing signaling between the Relay WTRU and the 5G network, while reducing any potential negative impact to a Remote WTRU to access a relay service due to failures during operations for other Remote WTRUs.

Issues relating to Relay triggering the ProSe SA using the Remote WTRU Report include reusing the Remote WTRU Report procedure to trigger the ProSe SA of Remote WTRUs, which is done after the establishment of the PC5 link between the Remote WTRU and the WTRU-to-Network Relay, and after the PDU Session establishment/modification, may have some impact to the communication establishment with the Relay WTRU. Namely, the IP address allocation procedure is triggered after the PC5 link establishment, however, the IP address allocation may also be handled at the DN-AAA server when performing a ProSe SA procedure. Moreover, since the PC5 link and PDU Session are established prior to the ProSe SA, there may be a waste of resources in the case where the ProSe SA procedure fails, i.e. the PC5 link and the PDU session are already established and would need to be released. In the case of re-use of a PDU session that is modified, it would need to be modified back to its previous state. Hence, embodiments are disclosed to reconcile potentially conflicting operations such as Remote WTRU IP address allocation, done by the 5G system during the PC5 link establishment with the Relay WTRU, and done by the DN-AAA server during the Remote WTRU Report procedure when ProSe SA for the WTRU is performed. Additionally, embodiments herein may address how to avoid wasting resources in case of ProSe SA failure.

Additional issues which may be address by the disclosed embodiments may relate to support for dynamic policy and charging control (PCC) for Remote WTRUs with ProSe SA/DN-AAA. For the existing PDU Session secondary authentication procedure, there is a case that dynamic PCC may be used. When dynamic PCC is used and when the SMF receives the information, including DN Authorization information received from the DN-AAA server, the information is shared with the PCF under a PDU session context. In the U2N Relay case with ProSe SA, ProSe SA is performed for a Remote WTRU using the PDU session of Relay WTRU to exchange data with the associated DN. Therefore, if the DN Authorization information is received from DN-AAA server as a result of ProSe SA for the Remote WTRU, the DN Authorization info is specifically to control the usage of the DN by Remote WTRU. However, according to the existing PDU Session secondary authentication, the information should be forwarded to the PCF under a PDU session context for the Relay WTRU. With the current mechanism, the PCF applies the received information to the PDU session of the Relay WTRU. This leaves an issue of how can the PCF be aware of which Remote WTRUs are using the PDU session of the Relay WTRU and how to apply a proper policy, e.g. based on DN authorization info from DN-AAA, to the flows of Remote WTRU inside PDU session of Relay WTRU? When the Remote WTRU moves to a different Relay WTRU, the Remote WTRU, Relay WTRU and the SMF need to repeat the same procedure of SA. Embodiments disclosed herein may address one or more of the foregoing issues including enhancing the operation when Remote WTRU moves to a different Relay WTRU to be more efficient when dynamic PCC is used.

Embodiments are described herein where locally configured DNN information is used to convey local information to the 5GC and the Relay WTRU to determine locally, that a DN is subject to ProSe SA. The embodiments allow supporting deployments where the serving PLMN may provide access to a DN locally (e.g., with LBO scenario) that requires DN-level authentication/authorization (e.g., enterprise network, public network integrated non-public network (PNI-NPN). Embodiments allow foregoing the need for a pre-established roaming agreement with the HPLMN regarding the DNN (i.e., the need for the DNN being pre-configured in the HPLMN) and need to check with the UDM for Remote WTRU DNN subscription data.

Embodiments are described herein where the Relay and 5GC may perform multiple ProSe SA procedures in parallel triggered by a single Remote UE/WTRU Report procedure. The proposed solution allows to continue the support for existing Remote WTRU procedure that enables reporting multiple Remote WTRU connections at once (i.e., preserve the saving on Relay-Network signaling), while supporting ProSe SA procedures and avoiding operations of the Remote WTRUs negatively impacting or interfering with one another.

Embodiments are described herein where the 5GC initiates ProSe SA procedures for a Remote WTRU during the PC5 link establishment with the Relay WTRU. The embodiments allow reconciliation of IP address allocation operations performed either by the 5GC or by the DN-AAA server, if required during ProSe SA, while preserving and utilizing the existing Remote WTRU Report procedure.

Further embodiments are described herein where the 5GC (e.g., the SMF and the PCF) supports dynamic PCC when ProSe SA procedure is required for a PDU session. The embodiments allow for the DN-AAA server to control the authorization and policy on a per individual Remote WTRU basis, sharing a PDU Session of a Relay WTRU, while preserving and utilizing the existing interface definition between the SMF and the DN-AAA server.

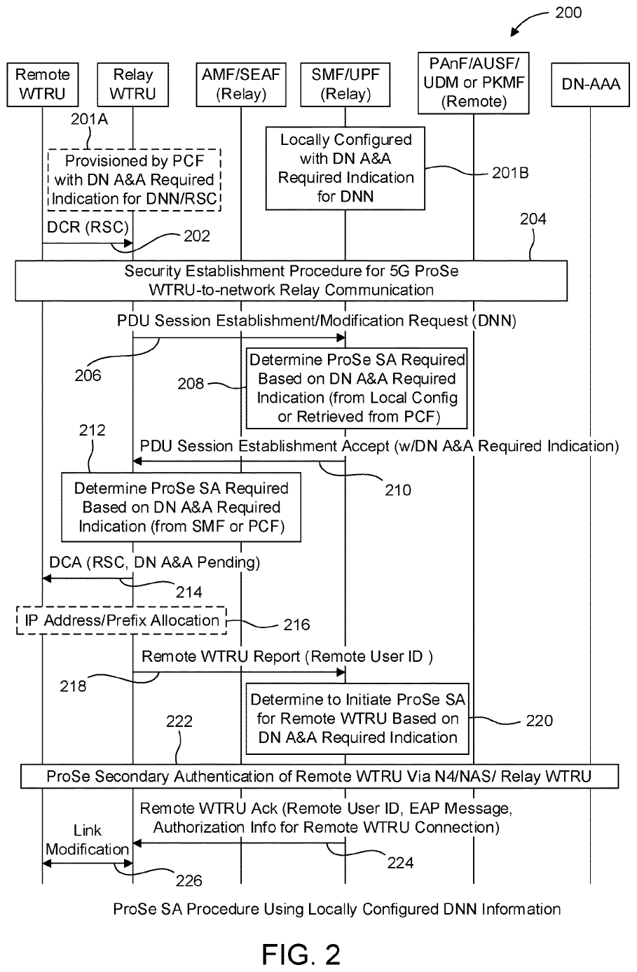

Referring to FIG. 2, a network diagram 200 for a ProSe SA procedure using locally configured DNN information is shown according to an example embodiment. Entities shown in network diagram 200 of FIG. 2 may include the Remote WTRU; the Relay WTRU; an access and mobility management function (AMF) and/or a security anchor function (SEAF); a session management function (SMF) and/or user plane function (UPF); a ProSe anchor function (PAnF)/ authentication server function (AUSF)/ unified data management (UDM) and/or ProSe key management function (PKMF); and a data network authentication, authorization and accounting (DN-AAA) server.

At Step 201A. the Relay WTRU may be configured with a DN A&A required indication associated with the relay service code (RSC)/data network name (DNN) during a provisioning procedure with the policy control function (PCF) (the PCF is not shown in network diagram 200 for simplification). The Remote WTRU may be configured with DN A&A required indication associated with the RSC/DNN during a provisioning procedure with the PCF. The Remote WTRU may determine it needs to perform a User Plane (UP) Remote Provisioning procedure to obtain credentials for a DN secondary authentication/authorization from a Provisioning Server (PVS) based on the indication (e.g., dedicated DNN for enterprise, PNI-NPN). At step 201B, the SMF is configured with a local configuration for a DNN used for Relaying with an associated DN A&A required indication.

At Step 202 the Relay WTRU receives a direct communication request (DCR) message from the Remote WTRU including a relay service code (RSC) and Remote User Identity (e.g., Remote User ID, subscriber concealed identifier (SUCI)). At Step 204, the Relay WTRU initiates and performs a security procedure with the network and the Remote WTRU for the authorization of the Remote WTRU to access the Relay service associated with the RSC. The Relay WTRU obtains a security key from the network (e.g., from an AMF or a PKMF) to check whether the Remote WTRU is authorized to use the relay service associated with RSC and to secure communication with the Remote WTRU. At Step 206, the Relay WTRU sends a PDU Session establishment or Session modification request message to the SMF including the DNN associated with the RSC.

In Step 208, the SMF determines whether to initiate ProSe SA and/or contact the UDM of the Remote WTRU to retrieve DN subscription data (e.g., DN info, general public subscription identifier (GPSI), based on PLMN agreements) based on the DN A&A required indication retrieved from the SMF's local configuration (configured in Step 201B) and/or provided by a PCF during a session management (SM) Policy Association Establishment/Modification procedure. The SMF may store the indication in the session management context of the Relay WTRU. At Step 210, the SMF sends a PDU Session establishment/modification response message to the Relay WTRU including a DN A&A required indication. At Step 212, the Relay WTRU determines, based on DN A&A required indication from the SMF (or PCF), that ProSe SA is required for the Remote WTRU. Next, at Step 214, the Relay WTRU sends to the Remote WTRU, a connection response (e.g., a direct communication accept (DCA)) including a “DN A&A required” indication associated with RSC/DNN.

At Step 216, the IP address/prefix allocation may be performed for the Remote WTRU by the Relay WTRU. In Step 218, the Relay WTRU sends a Remote WTRU Report request message to the SMF including the Remote WTRU identity (Remote User ID). At 220, the SMF determines to initiate ProSe SA for the Remote WTRU based on the “DN A&A required” indication and/or the subscription data retrieved from the UDM and/or whether the Remote WTRU has a prior authorization in the SM context of the Relay WTRU. Next, at Step 222, the Relay WTRU forwards ProSe SA messages back and forth between the SMF (from the DN-AAA server) and the Remote WTRU. The SMF obtains a DN-specific identity (including DN-AAA address) the first time from the Remote WTRU using an extensible authentication protocol (EAP) Request/Identity and stores it the SM context of the Relay WTRU. The SMF may use the DN-AAA address from the SM context of the Relay for subsequent ProSe SA towards the same DNN.

At Step 224, the SMF sends a Remote WTRU Report response message to the Relay including the result (e.g., EAP-success/failure) of the ProSe SA procedure for the Remote WTRU. At Step 226, the Relay WTRU authorizes the Remote WTRU access (e.g., using a Link Modification procedure) or denies access (e.g., PC5 link release procedure) passing the result of the ProSe SA procedure to the Remote WTRU.

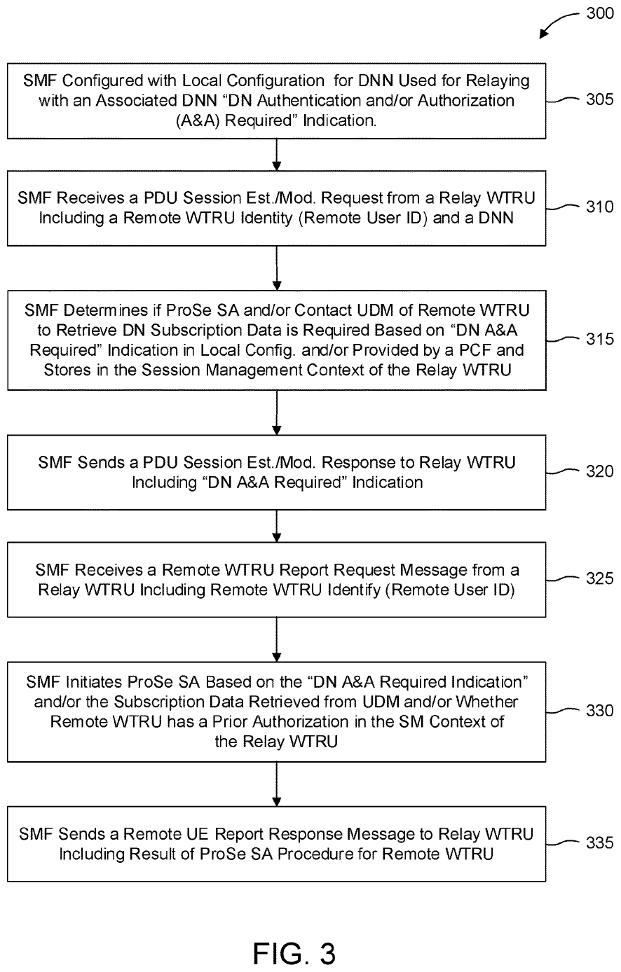

Referring to FIG. 3, a method 300 for a session management function (SMF) performing a ProSe SA procedure based on locally configured DNN information is shown. In this embodiment, the SMF uses an indication in the relaying DNN local configuration to determine whether to initiate a ProSe SA for a Remote WTRU and/or contact unified data management (UDM) of the Remote WTRU.

Initially, the SMF is configured 305 with a local configuration for a DNN used for Relaying with an associated “DN authentication and/or authorization (A&A) required” indication. The SMF next receives 310 a PDU Session establishment or modification request message from a Relay WTRU, including a Remote WTRU identity (Remote User ID) and a DNN. The SMF determines 315 whether a ProSe SA is required and/or to contact the UDM of Remote WTRU to retrieve DN subscription data (e.g., DNN info, general public subscription identifier (GPSI), based on PLMN agreements) based on a the DN A&A required indication retrieved from the SMF local configuration and/or provided by a policy control function (PCF). The SMF stores DN subscription data in the session management (SM) context of the Relay WTRU.

In some embodiments, the SMF next sends 320 a PDU Session establishment or modification response message to the Relay WTRU including a DN A&A required indication. The SMF may receive 325 a Remote WTRU Report request message from the Relay including a Remote WTRU identity (i.e., Remote User ID). The SMF may then initiate 330 a ProSe SA for the Remote WTRU based on the DN A&A required indication and/or the subscription data retrieved from UDM, and/or whether the Remote WTRU has a prior authorization in the SM context of the Relay WTRU. The SMF sends 335 a Remote WTRU Report response message to the Relay WTRU including the result of the ProSe SA procedure for the Remote WTRU.

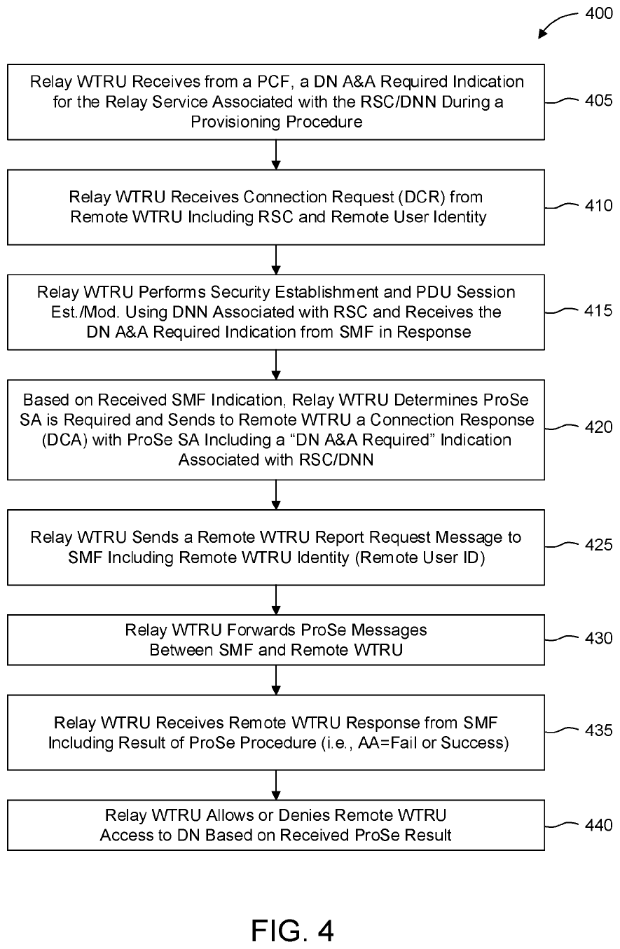

Referring to FIG. 4, a method 400 for a Relay WTRU performing a ProSe SA procedure with an SMF having locally configured DNN and A&A required indication is shown. In these embodiments, the Relay WTRU uses an indication from the PCF or from the SMF to determine that DN A&A (ProSe SA) is required for the DNN associated with the Relay service. In the example method 400, the Relay may be provisioned 405 by a PCF with DN A&A required indication for a Relay service associated with a relay service code (RSC)/data network name (DNN).

The Relay WTRU receives 410 a direct communication request (DCR) from a Remote WTRU including a RSC and Remote User identity. The Relay WTRU may next perform 415 security establishment and PDU Session establishment or modification for the DNN associated with the RSC and receives the DN A&A required indication from the SMF during the procedure. In one example, the Relay WTRU determines 420, based on a DN A&A required indication from the SMF, that ProSe SA is required for the Remote WTRU and sends to the Remote WTRU a connection response (e.g., direct communication accept (DCA)) with ProSe SA including a “DN A&A required” indication associated with RSC/DNN. Next, the Relay WTRU sends 425 a Remote WTRU Report request message to the SMF including a Remote WTRU identity (Remote User ID). At this point, the Relay WTRU forwards 430 ProSe SA messages back and forth between the SMF and the Remote WTRU.

Next, the Relay WTRU receives 435, from the SMF, a Remote WTRU Report response including the result of the ProSe SA procedure and the Relay WTRU allows or denies access 440 to the Remote WTRU based on the ProSe SA result received from SMF.

Additional embodiments are described herein where the Relay WTRU and 5GC may perform multiple ProSe SA procedures in parallel, which may be triggered by a single Remote WTRU Report procedure. These embodiments continue the support for established Remote WTRU procedures, but which enable reporting multiple Remote WTRU connections at once (i.e., preserve the saving on Relay-Network signaling), while supporting ProSe SA procedures and avoiding operations of the Remote WTRUs negatively impacting or interfering with one another. In these embodiments, methods to support multiple Remote User IDs in a Remote WTRU Report with ProSe SA may include the SMF providing the Relay WTRU with a specific status indication for each Remote User ID in the Remote WTRU Report ACK, based on individual operations progress of multiple Remote WTRUs authentication, and the SMF provides the Relay WTRU with final status in a subsequent message for each Remote User ID (Remote WTRU).

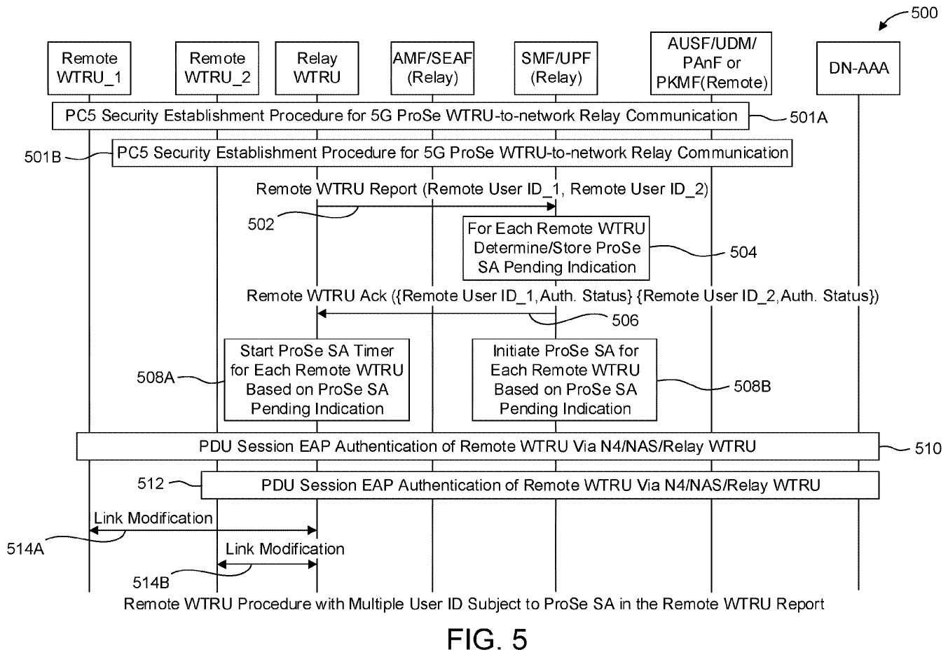

Referring to FIG. 5, a network diagram 500 illustrates an example method to support multiple Remote User IDs in a Remote WTRU Report with ProSe SA according to an embodiment. FIG. 5 illustrates a Remote WTRU Procedure with Multiple User IDs subject to ProSe SA in the Remote WTRU Report. Entities shown in network diagram 500 of FIG. 5 may include the multiple Remote WTRUs (e.g., Remote WTRU_1 and Remote WTRU_2); the Relay WTRU; an access and mobility management function (AMF) and/or a security anchor function (SEAF); a session management function (SMF) and/or user plane function (UPF); a ProSe anchor function (PAnF)/authentication server function (AUSF)/unified data management (UDM) and/or ProSe key management function (PKMF); and data network authentication, authorization and accounting (DN-AAA) server.

In Steps 501A and 501B, as part of each PC5 link establishment procedure with each Remote WTRU, the Relay WTRU receives from the respective Remote WTRU, a DCR message including a RSC and a Remote User Identity (e.g., Remote User ID, SUCI). The Relay WTRU initiates and performs a security procedure with the network and each Remote WTRU for the authorization of the Remote WTRU to access the Relay service associated with the RSC. The Relay WTRU obtains a security key from the network (e.g., from an AMF or a PKMF) to check whether the Remote WTRU is authorized to use the relay service associated with RSC and to secure communication with the Remote WTRU. The Relay sends to the Remote WTRU a DCA message to complete the PC5 link establishment. At Step 502, the Relay WTRU sends to the SMF, a Remote WTRU Report request message, including one or more Remote User ID(s), each identifying a Remote WTRU that successfully completed the PC5 link establishment (e.g., WTRU_1 and WTRU_2).

At Step 504, for each Remote User ID, the SMF determines whether the Remote WTRU is already authorized to access the DN or requires further DN level authorization based on information stored in the SM context of the Relay (e.g., available SUPI, authorization from DN-AAA). For Remote WTRU(s) that are not authorized, the SMF stores in the SM context of the Relay, the Remote User ID and an associated authorization (e.g., DN level) pending indication. At Step 506, the SMF sends to the Relay WTRU, a Remote WTRU Report Ack, including for each Remote WTRU, a Remote User ID and associated authorization status indication (e.g., authorized, pending DN level authorization).

The Relay WTRU may then grant access to Remote WTRU(s) with an authorized status indication in the Remote WTRU Report Ack. In one embodiment, the Relay WTRU may start 508A a ProSe SA timer for each Remote WTRU with an associated authorization pending indication in the Remote WTRU Report Ack. The SMF initiates 508B ProSe SA operations for each Remote WTRU with an authorization pending indication. At Steps 510 and 512, for each Remote WTRU subject to DN level authorization, the Relay WTRU forwards ProSe SA messages back and forth between the SMF (from the DN-AAA server) and the Remote WTRU. For each Remote WTRU, the Relay WTRU receives a final authentication response message from the SMF (e.g., PDU Session authentication result) indicating a success or failure result for the respective ProSe SA procedure. At Steps 514A and 514B, for each Remote WTRU that underwent a successful ProSe SA procedure, the Relay WTRU authorizes Remote WTRU access (e.g., using a Link Modification procedure) or denies access (e.g., PC5 link release procedure) passing the result of the respective ProSe SA procedure.

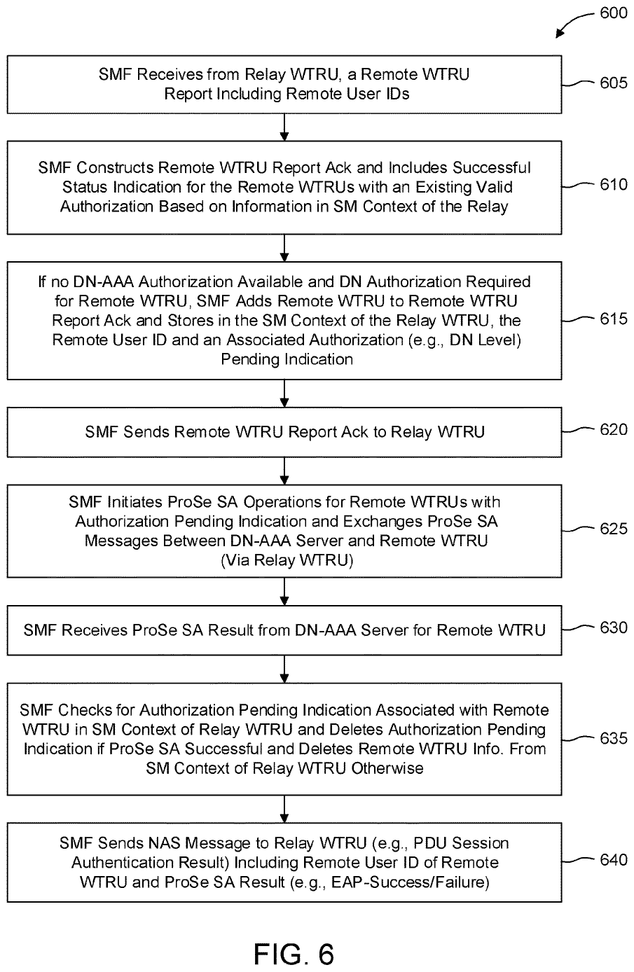

Turning to FIG. 6, a method 600 for a SMF to support multiple Remote User IDs in a Remote WTRU Report with ProSe SA is shown. In these embodiments, the SMF provides the Relay WTRU with a specific status indication for each Remote User ID in the Remote WTRU Report ACK/response based on individual operations progress and provides the Relay WTRU with updated/final status in a subsequent message

In method 600, the SMF receives 605 from a Relay WTRU, a Remote WTRU Report including multiple Remote User IDs. The SMF constructs 610 a Remote WTRU Report Ack and includes successful status indications for the Remote WTRUs with an existing valid authorization based on information in the SM context of the Relay (e.g., available subscription permanent identifier (SUPI), authorization from DN-AAA, etc.). In the situation that no DN-AAA authorization is available and DN authorization is required (e.g., based on the local config and/or subscription data) for the Remote WTRU, the SMF adds 615 to the Remote WTRU Report Ack and stores in the SM context of the Relay, the Remote User ID and an associated authorization (e.g., DN level) pending indication.

The SMF may then send 620 the Remote WTRU Report Ack to the Relay WTRU. The SMF initiates 625 ProSe SA operations for each Remote WTRU with an authorization pending indication and ProSe SA messages are exchanged between DN-AAA and Remote WTRU via the Relay WTRU. The SMF receives 630 a ProSe SA result message from the DN-AAA for the Remote WTRU pending authorization.

In some embodiments, the SMF checks 635 for an authorization pending indication associated with the Remote WTRU in the SM context of the Relay WTRU, and the SMF deletes the authorization pending indication if the ProSe SA is successful or deletes the Remote WTRU info from the SM context of the Relay if the authentication is unsuccessful. Next, the SMF may send 640 a non-access stratum (NAS) message to the Relay WTRU (e.g., PDU Session authentication result) including the Remote User ID of the Remote WTRU and the corresponding ProSe SA result (e.g., Extensible Authentication Protocol (EAP)-Success/Failure).

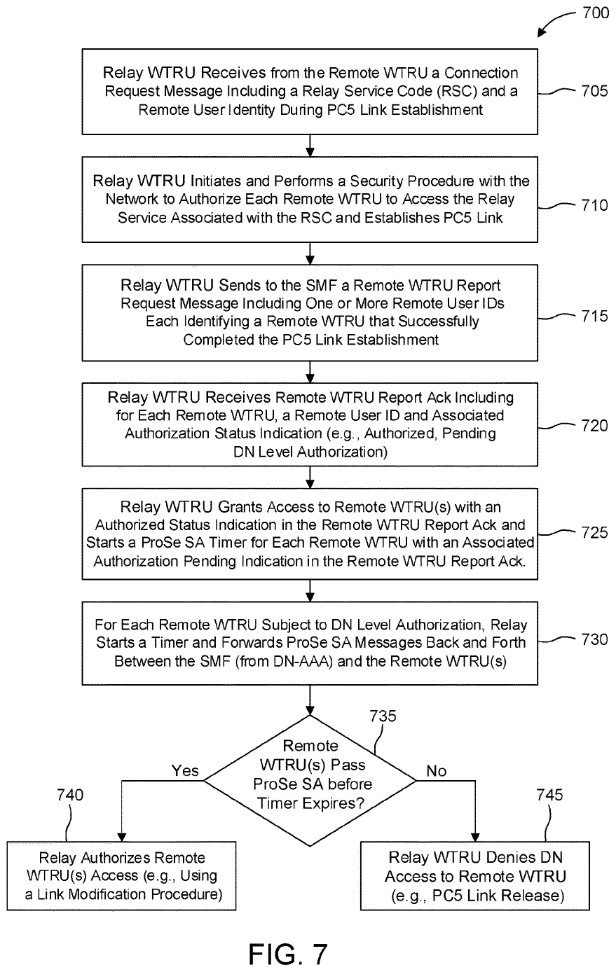

Referring to FIG. 7, a method 700 for a Relay WTRU to support multiple Remote User IDs in a Remote WTRU Report with ProSe SA is shown. In this example embodiment, the Relay WTRU allows or denies DN access to a Remote WTRU based on the specific status indication for the Remote WTRU received from the SMF in a Remote WTRU Report ACK or subsequent NAS message. Method 700 may begin with a Relay WTRU receiving 705, from a Remote WTRU, a connection request message including a relay service code (RSC) and a Remote User Identity during PC5 link establishment. The Relay WTRU initiates and performs 710 a security procedure with the network to authorize each Remote WTRU to access the Relay service associated with the RSC and establishes the PC5 link. In one example, the Relay WTRU sends 715 a Remote WTRU Report request message including multiple Remote User IDs to the network (e.g., the SMF). The Relay WTRU receives 720 a Remote WTRU Report Ack including multiple Remote User IDs, each with an associated specific status indication (e.g., authorized, authorization pending). The Relay WTRU allows 725 access to Remote WTRU(s) with an authorized status indication in the Remote WTRU Report Ack.

In some embodiments, the Relay WTRU starts 730 a ProSe SA timer for each Remote WTRU with an associated authorization pending indication in the Remote WTRU Report Ack and forwards ProSe SA messages between SMF (from DN-AAA server) and Remote WTRU(s). The Relay WTRU receives a message from the SMF (e.g., PDU Session authentication result) including the Remote User ID of the Remote WTRU and corresponding ProSe SA result (e.g., EAP-Success/Failure). The Relay WTRU may allow or deny access to the Remote WTRU(s) based on the ProSe SA result. In one embodiment, if 735 authorization indicated in the Remote WTRU Ack is received before the ProSe SA timer expires, the Relay WTRU allows DN access to the corresponding Remote WTRU(s) using a link modification procedure. Conversely, if 735 authorization for a Remote WTRU is not received from the SMF before expiration of the timer, the Relay WTRU denies 745 DN access to the corresponding Remote WTRU(s) and releases the PC5 link with that Remote WTRU. In another example, the Relay WTRU may re-send a Remote WTRU report request including the Remote User ID of any Remote WTRU for which the ProSe SA timer has expired, and the ProSe SA process is repeated for a given number of attempts or an amount of time.

In yet further embodiments, support may be enabled for ProSe SA using a Relay PDU Session Establishment or Modification procedure.

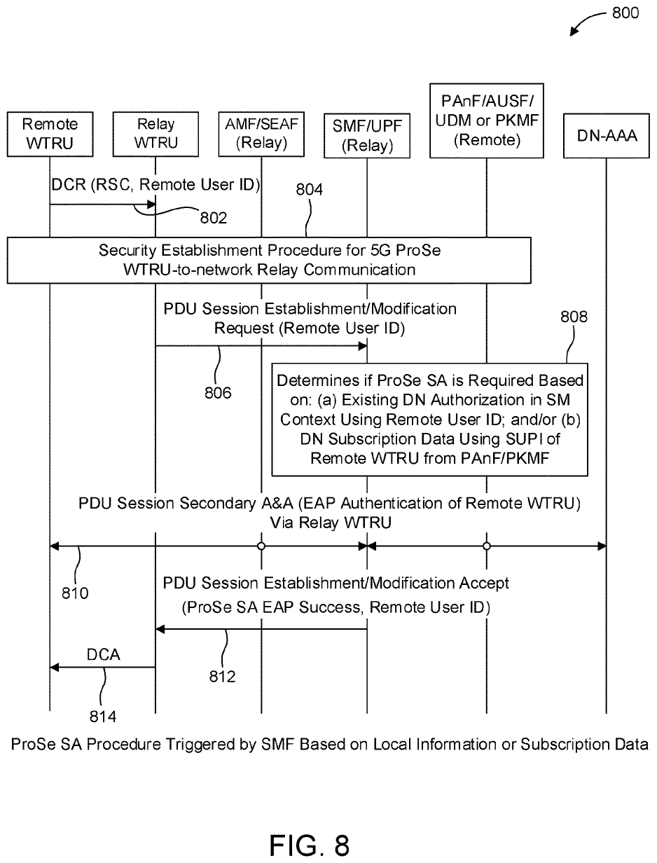

Referring to FIG. 8, a network diagram 800 illustrates an example method for ProSe SA during Relay WTRU PDU Session Establishment/Modification. FIG. 8 illustrates a ProSe SA procedure triggered by the SMF based on local information in SM context or subscription data of the Remote WTRU. The ProSe SA procedure may be triggered prior to the completion of the PC5 link establishment between the Remote WTRU and the Relay WTRU, as well as prior to completion of the PDU Session establishment/modification procedure with the Relay WTRU. Entities shown in network diagram 800 of FIG. 8 may include the Remote WTRU; the Relay WTRU; an access and mobility management function (AMF) and/or a security anchor function (SEAF); a session management function (SMF) and/or user plane function (UPF); a ProSe anchor function (PAnF)/authentication server function (AUSF)/unified data management (UDM) and/or ProSe key management function (PKMF); and data network authentication, authorization and accounting (DN-AAA) server.

In one example method, at Step 802, the Relay WTRU receives a direct connection request (DCR) message from the Remote WTRU including an RSC and a Remote User Identity (e.g., Remote User ID). At Step 804, the Relay WTRU initiates and performs a security procedure with the network and Remote WTRU for the authorization of the Remote WTRU to access the Relay service associated with the RSC. In Step 806, the Relay WTRU sends a PDU Session establishment/modification request message to the SMF including the DNN associated with the RSC and the Remote User ID. At Step 808, the SMF determines whether to initiate ProSe SA by verifying if a ProSe SA is required by the DNN for the Remote WRU. In certain embodiments, the SMF does this verification by: (i) checking for an existing DN authorization for the Remote WTRU in the SM context of Relay using the Remote User ID; and/or (ii) checking for DN subscription data of the Remote WTRU from the UDM using the SUPI of the Remote WTRU retrieved by SMF from a ProSe anchor function (PAnF)/ProSe key management function (PKMF).

At Step 810, the SMF initiates the ProSe SA procedure for the Remote WTRU with the DN-AAA server. In Step 812, the SMF sends to the Relay WTRU, a PDU Session establishment/modification accept/reject message including the ProSe SA result (e.g., EAP-success/failure) and the Remote User ID. At Step 814, the Relay WTRU sends a direct connection accept (DCA) message to the Remote WTRU in the case where the ProSe SA was successful. In this case, the PDU Session and the PC5 link are successfully established. Alternatively, the Relay WTRU sends a DCR reject in the case where the ProSe SA failed. In this case, the PDU Session and the PC5 link are not established. If the intent was to re-use a PDU session (PDU session modification), the PDU Session may be maintained, but the modifications are not applied.

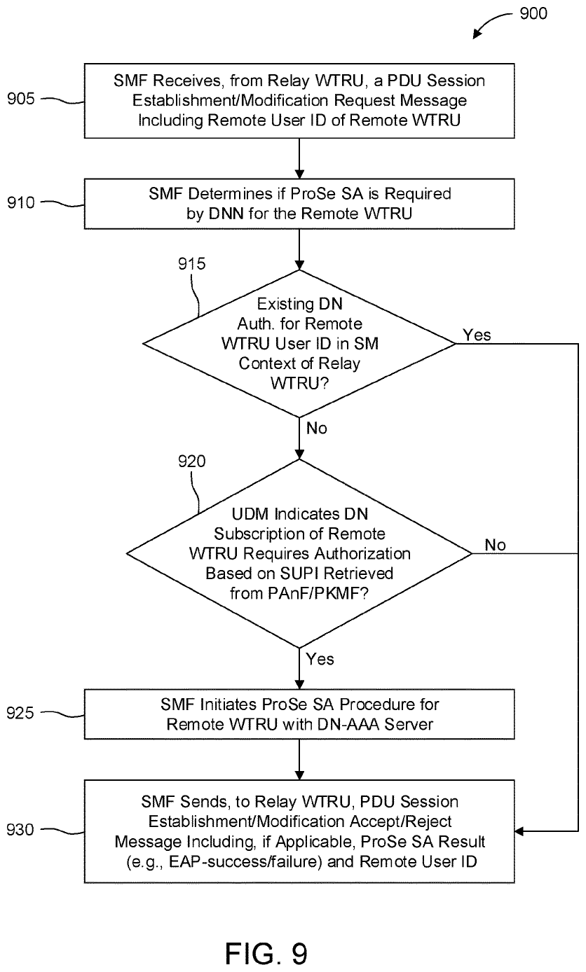

Turning to FIG. 9, a method 900 for an SMF providing ProSe SA during Relay WTRU PDU Session Establishment/Modification is shown. In these embodiments, the SMF triggers a Remote WTRU ProSe SA procedure on reception of a PDU Session Establishment/Modification Request from the U2N Relay (i.e. Relay WTRU), based on local information regarding the Remote WTRU in the session management (SM) context of the Relay WTRU or subscription data of the Remote WTRU. In method 900, the SMF receives 905 from the U2N Relay (i.e., Relay WTRU), a PDU Session Establishment/Modification Request message that includes the Remote User ID of a Remote WTRU.

The SMF may next determine 910, whether a ProSe SA is required for the DNN of the Remote WTRU. In various embodiments, the SMF may check for an existing DN authorization for the Remote WTRU in the SM context of the Relay WTRU using the Remote User ID. If 915, there is no existing DN authorization for the Remote WTRU, the SMF may check whether an authorization is required in DN subscription data of the Remote WTRU. In one example, the SMF checks with the UDM using the subscription permanent identifier (SUPI) of the Remote WTRU, which is retrieved by the SMF from a ProSe anchor function (PAnF)/ProSe Key Management function (PKMF). If 920, UDM indicates DN authorization is required for the Remote WTRU, the SMF initiates 925 the ProSe SA procedure for the Remote WTRU with the DN-AAA server. Upon completion of the ProSe procedure, the SMF sends 930 to the Relay WTRU, a PDU Session Establishment/Modification Accept or Reject message including any ProSe SA result (e.g., EAP-success/failure) and the Remote User ID.

If 915, an authorization for the Remote WTRU exists in the Relay SM context, or if 920, it is determined that DN authorization is not required based on the Remote WTRU DN subscription data from the UDM, the SMF sends 930 the Relay WTRU the PDU Session Establishment/Modification Accept enabling Remote WTRU access to the DN.

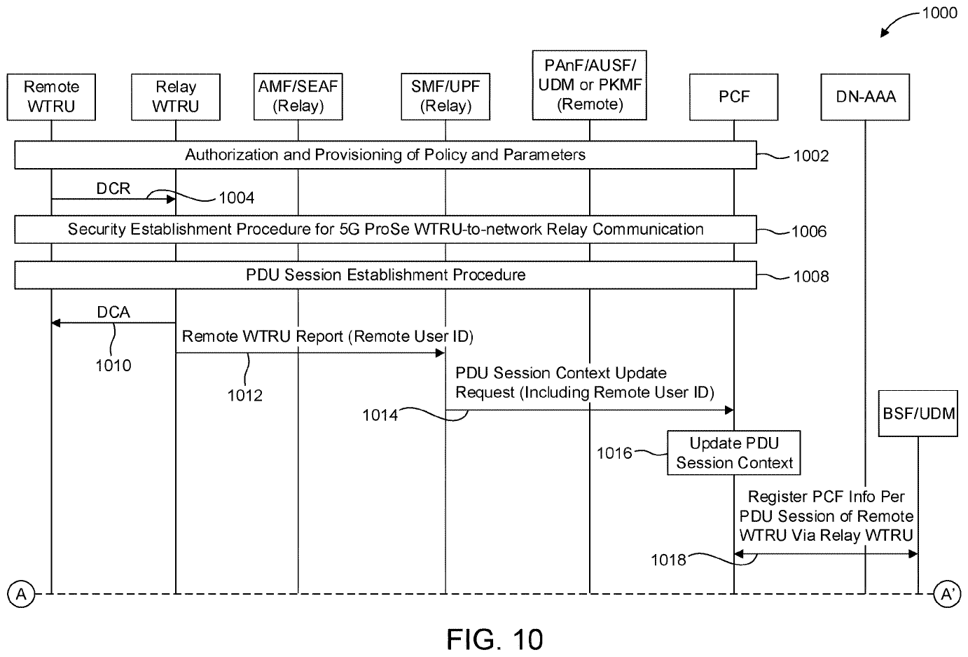

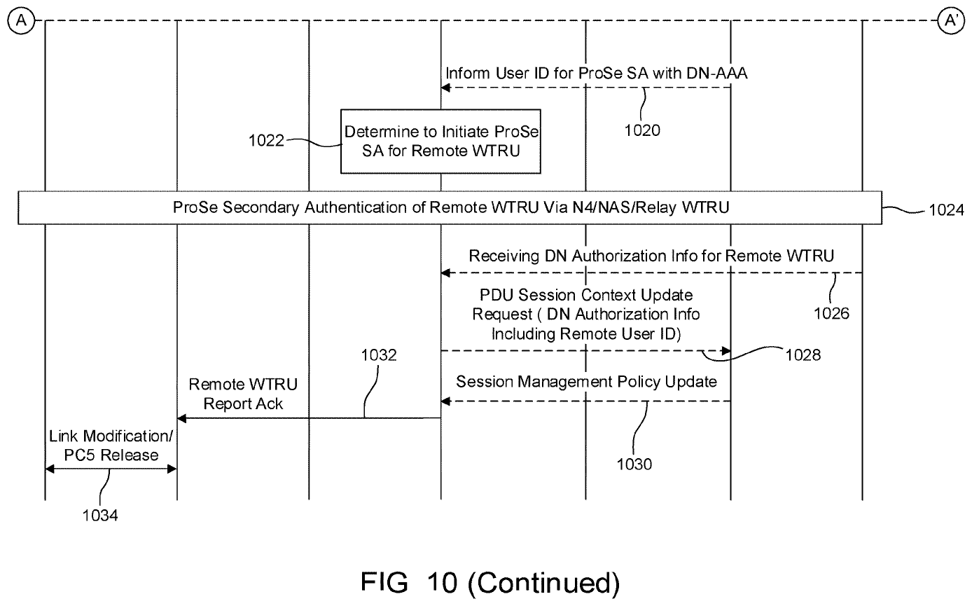

Additional embodiments are related to support for dynamic Policy and Charging Control (PCC) for ProSe SA. Referring to FIG. 10, a network diagram 1000 illustrates an example method for supporting dynamic PCC with ProSe SA. Entities shown in network diagram 1000 of FIG. 10 may include a Remote WTRU; a Relay WTRU; an access and mobility management function (AMF) and/or a security anchor function (SEAF); a session management function (SMF) and/or user plane function (UPF); a ProSe anchor function (PAnF)/ authentication server function (AUSF)/ unified data management (UDM) and/or ProSe key management function (PKMF); a policy control function (PCF); a data network authentication, authorization and accounting (DN-AAA) server and a binding support function (BSF). It is noted that in the example procedure illustrated in FIG. 10, the SMF is triggered based on a Remote Report received from the Relay WTRU, but could be alternatively triggered with a PDU Session establishment/modification message from the Relay WTRU.

Based on received information, in these embodiments, the PCF manages PDU session context of the Relay WTRU including each Remote WTRU which uses/shares the PDU session via the Relay WTRU. Additionally, the PCF manages PDU session context per Remote WTRU. The PDU session context per Remote WTRU may include information such as DNN, indication whether ProSe SA is required to access the DNN, indication of successful ProSe SA if required for the DNN, WTRU ID used for ProSe SA, and information indicating that the PDU session is via the Relay WTRU's PDU session and WTRU ID of the Relay WTRU. The PCF may decide and update allowed aggregate maximum bit rate (AMBR) of the Remote WTRU for accessing the DNN, based on the subscribed AMBR and information included in DN Authorization info from the DN-AAA server, which may be informed to the SMF and the Relay WTRU.

In FIG. 10, Step 1002, the Relay WTRU and Remote WTRU obtain authorization for using ProSe service including UE2NW relay service and are provisioned with associated policy and parameters. At Step 1004, based on the configured parameters, the Remote WTRU may send a direct communication request (DCR) including a relay service code (RSC) and Remote User ID. In Step 1006, after receiving the DCR, the Relay WTRU initiates and performs a security procedure with the network and the Remote WTRU for the authorization of the Remote WTRU to access the relay service associated with the RSC. The Relay WTRU obtains a security key from the network (e.g., from an AMF or a PKMF) to check whether the Remote WTRU is authorized to use the relay service associated with RSC and to secure communication with the Remote WTRU.

At Step 1008, the Relay WTRU may begin a PDU session establishment/modification procedure with the SMF including the DNN associated with the RSC. In Step 1010, the Relay WTRU may send a direct communication accept (DCA) as a response to the DCR from Remote WTRU. In Step 1012, The Relay WTRU sends a Remote WTRU Report request message to the SMF including one or more Remote WTRU identities (Remote User ID). In some embodiments, the remaining Steps may alternatively be performed as part of the PDU Session establishment/modification procedure (Step 1008) instead of during the Remote WTRU Report procedure (Step 1012). In other words, the remaining may be initiated in Step 1008. instead of after Step 1012, i.e., when receiving PDU session establishment/modification request instead of the Remote WTRU Report.

At Step 1014, the SMF sends a PDU session context update request to the PCF, to inform the received Remote WTRU identity(s) to the PCF associated to the PDU session of Relay WTRU. Additionally, and/or alternatively, the Remote WTRU's information may be informed during Step 1008, and in this case, the SMF may inform the Remote WTRU identity to the PCF associated with the PDU session of the Relay WTRU during the PDU session establishment procedure. At Step 1016, when receiving the Remote WTRU information, the PCF updates PDU session context of the Relay WTRU to include the Remote WTRU's information. Additionally, the PCF may manage the PDU session context of the Remote WTRU, which includes the DNN, PDU session information of the Relay WTRU, and indication that the Remote WTRU is using the PDU session via Relay WTRU.

At Step 1018, the PCF may update the UDM to include the PCF information subscription data of the Remote WTRU relating to the PDU session and the PCF may register its information to the binding support function (BSF) with the Remote WTRU's information so that the 5GC, or other entity, may find the PCF relating to the PDU session of Remote WTRU. The update to the UDM and registration at the BSF may include information that the PCF is managing the Remote WTRU for access of PDU session via the Relay WTRU, which can be identified by the IP address of the Remote WTRU, DNN, S-NSSAI, etc.

In Step 1020, when the PDU session is subject to ProSe SA and the PCF finds a User ID to be used for authentication/authorization with DN-AAA in the context of a Remote WTRU, the PCF may inform the User ID to the SMF. At Step 1022, the SMF may determine and initiate the ProSe SA for the Remote WTRU based on the DN A&A required indication, and/or the subscription data retrieved from the UDM, and/or based on the received User ID and indication from the PCF. At Step 1024, the Relay WTRU forwards ProSe SA messages back and forth between the SMF (from the DN-AAA server) and the Remote WTRU. The SMF may use the received User ID from the PCF at Step 1020 as a DN-specific identity (including DN-AAA address) of the Remote WTRU for communicating with the DN-AAA server.

At Step 1026, after successful DN authentication/authorization, the DN-AAA server may send DN authorization information for the Remote WTRU to the SMF. The DN authorization information may include whether authentication/authorization is successful, any policy relating parameter to access the DN, e.g., AMBR for DN access, policy index to apply among the preconfigured index set between DN-AAA and 5GC, etc.

In Step 1028, the SMF may inform the PCF of the result of DN authorization with the Remote WTRU's information. The result of DN authorization may include whether authentication/authorization is successful, any policy relating parameter received from the DN-AAA server, and User ID of the Remote WTRU which is used for communication with the DN-AAA server. The PCF updates the Remote WTRU's context and Relay WTRU's PDU session context based on the received information.

At Step 1030, if needed, the PCF may update policy, e.g., AMBR for flows of the Remote WTRU using the PDU session of the Relay WTRU based on the received information from Step 1028, session AMBR of the PDU session of the Relay WTRU to support updated policy of the Remote WTRU, and informs the SMF of the updated result. In Step 1032, the SMF may send a Remote WTRU Report response message to the Relay WTRU including the result (e.g., EAP-success/failure) of the ProSe SA procedure for the Remote WTRU. At Step 1034, the Relay WTRU authorizes the Remote WTRU access (e.g., using a Link Modification procedure) or denies access (e.g., PC5 link release procedure) passing the result of the ProSe SA procedure.

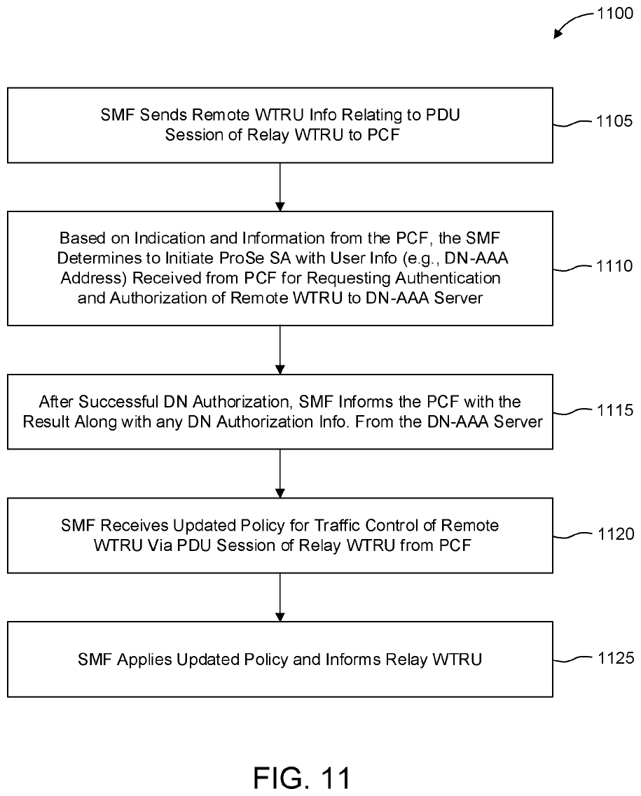

Referring to FIG. 11, a method 1100 for an SMF supporting dynamic PCC with ProSe SA is shown. In these embodiments, the SMF provides the policy control function (PCF) with the Remote WTRU's information using the PDU session of the Relay WTRU and when there is any update on the Remote WTRU's information for accessing the PDU session of the Relay WTRU, e.g. DN authorization info from DN-AAA after successful authorization, the SMF informs the updated information to the PCF.

In method 1100, the SMF provides the PCF with the Remote WTRU's information using the PDU session of the Relay WTRU and when there is any update on the Remote WTRU's information for accessing the PDU session of Relay WTRU, e.g. DN authorization info from DN-AAA after successful authorization, the SMF informs the updated information to the PCF.

In method 1100, the SMF sends 1105 the Remote WTRU information relating to the PDU session of the Relay WTRU to the PCF. Based on indication and information from the PCF, the SMF decides 1110 to initiate ProSe SA and the SMF uses User Info (e.g., including DN-AAA address) received from PCF for requesting authentication and authorization of the Remote WTRU to the DN-AAA server.

After successful DN authorization, the SMF informs 1115 the PCF with the A&A result, along with any DN authorization info from the DN-AAA server. Next, the SMF receives 1120 updated policy information for traffic control of the Remote WTRU via the PDU session of Relay WTRU from the PCF. The SMF may apply 1125 the updated policy and inform the Relay WTRU.

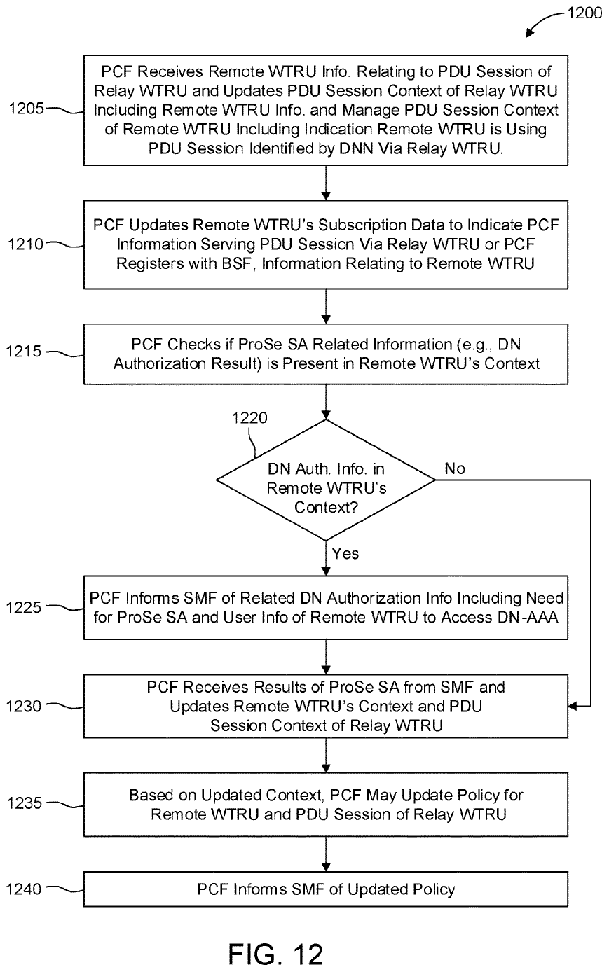

Referring to FIG. 12, a method 1200 for a PCF supporting dynamic PCC for ProSe SA is shown. In these embodiments, based on the received information from SMF, the PCF manages PDU session context per Remote WTRU. The PCF may update the Remote WTRU's subscription data to indicate the PCF for the PDU session via the Relay WTRU or register with a binding support function (BSF) its information relating to Remote WTRU.

In method 1200, the PCF receives 1210 the Remote WTRU information relating to the PDU Session of the Relay WTRU and updates the PDU session context of the Relay WTRU including the Remote WTRU information and manages the PDU session context of Remote WTRU, which may include indication that the Remote WTRU is using a PDU session identified by the data network name (DNN) via the Relay WTRU.

The PCF updates 1210 the Remote WTRU's subscription data to indicate PCF information of the serving PDU session via the Relay WTRU. Alternatively, or in addition, the PCF registers with the binding support function (BSF) its information relating to the Remote WTRU. In the 5GC, the BSF may be used for binding an application/function request to a specific PCF instance and allows all messages from a same subscriber from different interfaces and a specific session be routed to the same PCF.

The PCF checks 1215 if any ProSe SA related information, for example a DN authorization result, is present in the Remote WTRU's context. If 1220, the PCF detects ProSe SA related information in Remote WTRU's context, the PCF informs 1225 the SMF, which may include indication of needs of ProSe SA and User Info of the Remote WTRU to access the DN-AAA server.

When receiving results of the ProSe SA from the SMF, the PCF may update 1230 the Remote WTRU's context and the PDU session context of the Relay WTRU. Based on the updated context, the PCF may update 1235 policy for the Remote WTRU and the PDU session of Relay WTRU. The PCF informs 1240 the updated policy to SMF.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a relay wireless transmit and receive unit (WTRU), the method comprising:
receiving, from a policy control function (PCF) during a relay service provisioning procedure, a data network (DN) authentication and authorization (A&A) required indication for the relay service, the DN A&A required indication associated with at least one of a relay service code (RSC) or a data network name (DNN);
receiving, from a remote WTRU, a connection request including the RSC and a remote user identity;
sending, to a session management function (SMF), a packet data unit (PDU) session establishment or modification request message including the remote user identity and the DNN associated with the RSC received from the remote WTRU;
receiving, from the SMF, a PDU session accept message including a related DN A&A required indication associated with the DNN;
determining, based on the related DN A&A required indication from the SMF, a proximity services secondary authentication (ProSe SA) procedure is required for the remote WTRU; and
sending, to the remote WTRU, a connection accept response indicating the ProSe SA procedure associated with the DNN is required.

2. The method of claim 1, further comprising:
sending, to the SMF, a remote WTRU report request message including the remote user identity; and
forwarding ProSe SA messages between the SMF and the remote WTRU.

3. The method of claim 2, further comprising:
receiving from the SMF, a remote WTRU report response including a result of the ProSe SA procedure for the remote WTRU; and
modifying a connection with the remote WTRU based on the result of the ProSe SA procedure received in the remote WTRU report response.

4. The method of claim 3, wherein the result of the ProSe SA procedure is successful and a link modification is performed to enable the remote WTRU to access the DN.

5. The method of claim 3, wherein the result of the ProSe SA procedure is unsuccessful and a PC5 connection with the remote WTRU is released.

6. A relay wireless transmit and receive unit (WTRU) comprising:
a transceiver and a processor operatively coupled with the transceiver, the transceiver and processor configured to:
receive, from a policy control function (PCF) during a relay service provisioning procedure, a data network (DN) authentication and authorization (A&A) required indication for a corresponding relay service, the DN A&A required indication associated with at least one of a relay service code (RSC) or a data network name (DNN);
receive, from a remote WTRU, a connection request including the RSC and a remote user identity;
send, to a session management function (SMF), a packet data unit (PDU) session establishment or modification request message including the remote user identity and the DNN associated with the RSC received from the remote WTRU;
receive, from the SMF, a PDU session accept message including a related DN A&A required indication associated with the DNN;
determine, based on the related DN A&A required indication from the SMF, a proximity services secondary authentication (ProSe SA) procedure is required for the remote WTRU; and
send, to the remote WTRU, a connection accept response indicating the ProSe SA procedure associated with the DNN is required.

7. The relay WTRU of claim 6, wherein the transceiver and processor are further configured to:
send, to the SMF, a remote WTRU report request message including the remote user identity; and
forward ProSe SA messages between the SMF and the remote WTRU.

8. The relay WTRU of claim 7, wherein the transceiver and processor are further configured to:
receive from the SMF, a remote WTRU report response including a result of the ProSe SA procedure for the remote WTRU; and
modify connection with the remote WTRU based on the result of the ProSe SA procedure received in the remote WTRU report response.

9. The relay WTRU of claim 8, wherein the result of the ProSe SA procedure is successful and a link modification is performed to enable the remote WTRU to access the DN.

10. The relay WTRU of claim 8, wherein the result of the ProSe SA procedure is unsuccessful and a PC5 connection with the remote WTRU is released.

11. A method for a network node including a session management function (SMF), the method comprising:
storing local configuration information of a data network (DN) used for relay service, including at least one DN name (DNN) and an associated DN authentication and authorization (A&A) required indication;
receiving a packet data unit (PDU) session establishment or modification request from a relay wireless transmit receive unit (WTRU) for DN access by a remote WTRU, including a remote user identity and an indicated DNN;
determining proximity services (ProSe) secondary authentication (SA) is required for the remote WTRU based, at least in part, on the remote user identity, the indicated DNN and the local configuration information;
sending a PDU session establishment or modification response to the relay WTRU including an indication that DN A&A is required for the remote WTRU;
receiving a remote WTRU report request message from the relay WTRU including the remote user identity;
initiating a ProSe SA procedure for the remote WTRU based on the received remote WTRU report request; and
sending a remote WTRU report response message to the relay WTRU including a result of the ProSe SA procedure.

12. The method of claim 11, wherein determining ProSe SA is required is further based on one or more of information received from unified data management (UDM) subscription data for the remote WTRU or information received from a policy control function (PCF).

13. The method of claim 11, further comprising:
storing, in a session management context of the relay WTRU, at least one of the indication that DN A&A is required or the result of the ProSe SA procedure.

14. The method of claim 11, wherein the remote WTRU report response message includes the remote user identity, an extensible authentication protocol (EAP) message and authorization information for connection of the remote WTRU.
